(19) United States
(12) Patent Application Publication
(10) Pub. No.: US 2006/0248466 A1
(43) Pub. Date: Nov. 2, 2006

(54) Integration of multiple programming/scripting languages into one program unit

(75) Inventors: Igor Fedorenko, North York (CA); Andrew Niel Trossman, North York (CA)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 11/117,149

(22) Filed: Apr. 28, 2005

(51) Int. Cl. G06F 3/00; G06F 17/00

(52) U.S. Cl. 715/744

(57) ABSTRACT

There is provided a workflow language for joining multiple scripts written in different programming languages. The workflow program may then be created using a new workflow language. The workflow language acts as a glue that embeds each desired script into a workflow program that may then integrate input, output, logging, error handling, data transfer, and other functions of each desired script.

### BACKGROUND OF THE INVENTION

1. Technical Field

The present invention relates generally to an improved data processing system and in particular to a method and apparatus for processing data. Still more particularly, the invention relates to a method, apparatus, and computer instructions for integration of multiple programming or scripting languages into one program unit.

2. Description of Related Art

A system manager of a data center often faces the daunting challenge of managing a great number of computers in the data center. Workflows to manage data centers often require execution of multiple management programs, or scripts or scriptlets, on many different computers or data processing systems in the data center. Often, different management programs are written in different programming languages. Furthermore, different data processing systems in the data center may use different types of application program interfaces, thereby complicating the problem. Each different application program interface may be able to handle one or a few programming languages, but not others. Thus, if a desired script is written in a programming language incompatible with an application program interface, then the system manager must write two separate scripts and execute each individually with regard to their respective application program interfaces. In addition, if multiple desired scripts are to be executed on a target data processing system, then each script must be individually executed on the target data processing system. This process can be difficult, tedious, wasteful of resources, and time-consuming. Thus, it would be advantageous to have an improved method, apparatus, and computer instructions for simplifying the task of managing data centers using scripts.

### SUMMARY OF THE INVENTION

The present invention provides a method, apparatus, and computer instructions for coordinating multiple scripts in a single workflow program. The workflow program is created using a novel workflow language. The workflow program coordinates parameters among the scripts embedded in the workflow program, such as input, output, logging, error handling, data transfer, and other parameters. Each script may be written in a different programming language. Thus, a workflow program may be executed on a data processing system to accomplish the tasks of each individual script embedded in the workflow program, even if the input of one script may depend on the output of another script or if the scripts were written in different programming languages.

### BRIEF DESCRIPTION OF THE DRAWINGS

The novel features believed characteristic of embodiments of the invention are set forth in the appended claims. The embodiments of the invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which embodiments of the present invention may be implemented.

FIG. 2 is a block diagram of a data processing system in which embodiments of the present invention may be implemented.

FIG. 3 is a block diagram of a data center in which embodiments of the present invention may be implemented.

FIG. 4 is a block diagram of a data processing job that may be implemented using embodiments of the present invention.

FIG. 5 is a flowchart illustrating a prior art method of executing a job on a single data processing.

FIG. 6 is a flowchart illustrating a prior art method of accomplishing the data processing job shown in FIG. 4.

FIG. 7 is a block diagram of a data processing job, in accordance with an embodiment of the present invention.

FIG. 8 is a flowchart illustrating a method of accomplishing the data processing job shown in FIG. 6, in accordance with an embodiment of the present invention.

FIG. 9 is a flowchart illustrating an example of an operation of a workflow execution engine, in accordance with an embodiment of the present invention.

FIG. 10 is an example of BASH input bindings, in accordance with an embodiment of the present invention.

FIG. 11 is an example of BASH output bindings, in accordance with an embodiment of the present invention.

FIG. 12 shows an example of a workflow program, in accordance with an embodiment of the present invention.

### DETAILED DESCRIPTION OF THE PREFERRED EMBODIMENT

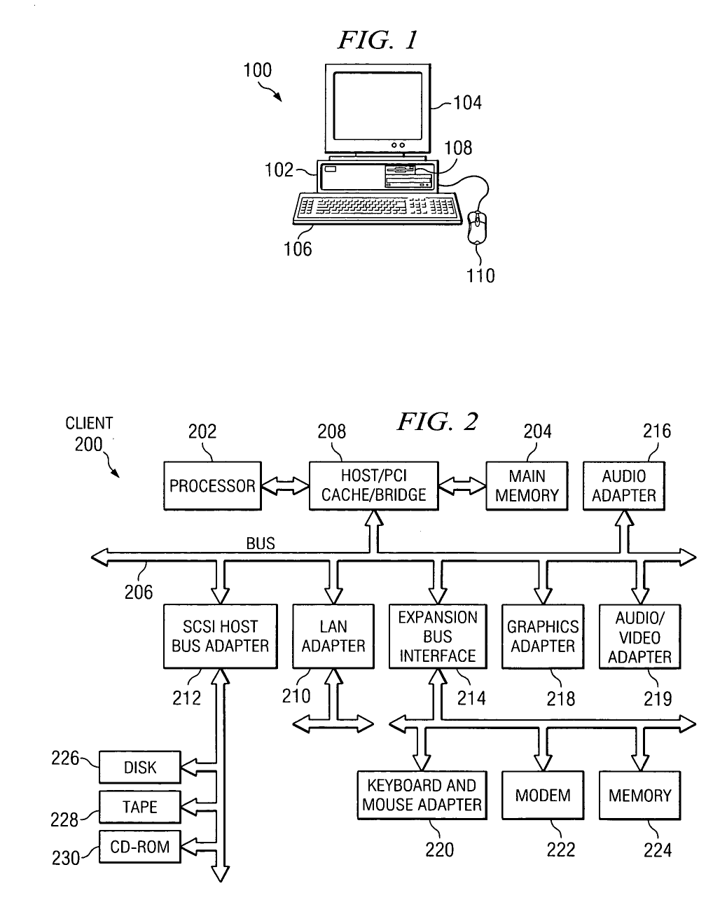

With reference now to the figures and in particular with reference to FIG. 1, a pictorial representation of a data processing system in which embodiments of the present invention may be implemented is depicted. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eServer™ computer or IntelliStation™ computer, which are products of International Business Machines Corporation™, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which embodiments of the present invention may be implemented. Data processing system 200 is an example of a computer, such as computer 100 in FIG. 1, in which code or instructions implementing the processes of embodiments of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in connectors. In the depicted example, local area network (LAN) adapter 210, small computer system interface (SCSI) host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows XP™, which is available from Microsoft Corporation™. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, includes some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

The processes of embodiments of the present invention are performed by processor 202 using computer implemented instructions, which may be located in a memory such as, for example, main memory 204, memory 224, or in one or more peripheral devices 226-230.

Embodiments of the present invention provide a method, apparatus, and computer instructions for coordinating multiple scripts in a single workflow program. The workflow program is created using a novel workflow language. The workflow program coordinates parameters among the scripts embedded in the workflow program, such as input, output, logging, error handling, data transfer, and other parameters. Each script may be written in a different programming language. Thus, a workflow program may be executed on a data processing system to accomplish the tasks of each individual script embedded in the workflow program, even if each the input of one script depends on the output of another script and even if the scripts are written in different programming languages.

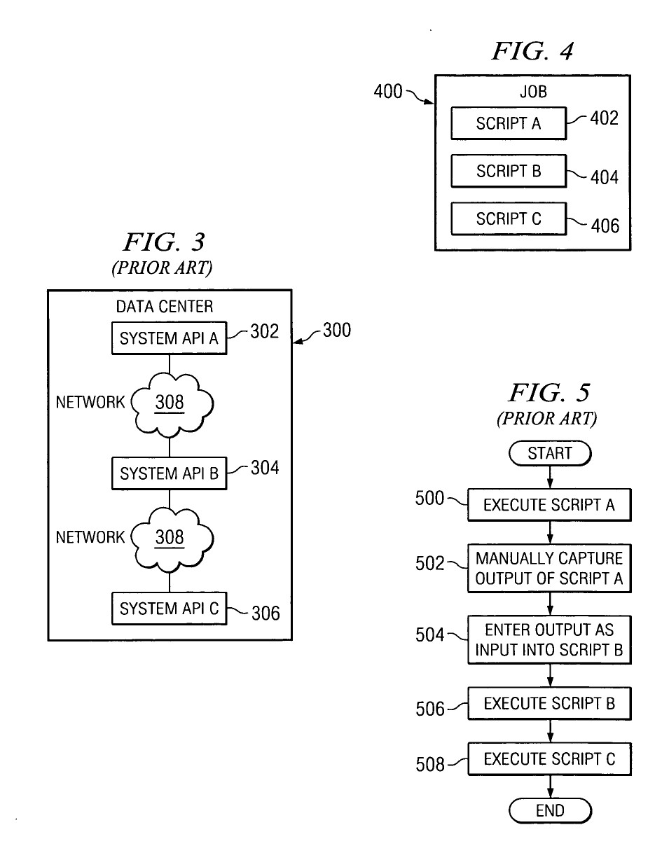

FIG. 3 is a block diagram of a data center 300 in which the present invention may be implemented. The data center contains one or more data processing systems, such as data processing systems 302, 304, and 306. Each data processing system may be a computer, such as data processing system 100 in FIG. 1 or data processing system 200 in FIG. 2, and may take the form of a client, a server, a cluster of servers, a computing grid, or any other data processing system. Each data processing system 302, 304, and 306 is connected via one or more networks, such as network 308. A network may be a local area network, a wide area network, the Internet, or any other suitable means for communication between computers.

Each data processing system 302, 304, or 306 may use an application program interface (API) that is different from the other data processing systems. An application program interface is the interface, or set of calling conventions, by which an application program accesses an operating system and other computer services. An application program interface is defined at a source code level and provides a level of abstraction between the application kernel and the application to ensure the portability of program code. The kernel is the essential part of an operating system responsible for resource allocation, low-level hardware interfaces, security, etc. An application program interface can also provide an interface between a high level language and lower level utilities and services which were written without consideration for the calling conventions supported by the compiled languages. The term “application program interface” as used herein refers to both types of functions in a data processing system.

In the illustrative example, API A is a first application program interface, API B is a second application program interface, and API C is a third application program interface. Each API, API A, API B, and API C, is different from the other in this example. Thus, programs running on each data processing system 302, 304, and 306 are written in different programming languages.

FIG. 4 is a block diagram of a data processing job 400 that may be implemented using the present invention. Job 400 will be performed on each data processing systems in a data center. In this example, job 400 is to configure each data processing system, 302, 304, and 306 in FIG. 3. Each script, Script A 402, Script B 404, and Script C 406, accomplishes the same configuration goal. However, each script is written in a different programming language because each data processing system, 302, 304, and 306, supports a different programming language. The process of writing and executing each script is tedious.

In another illustrative example, each script in job 400 will be run on a single data processing system. In this example, each script accomplishes a different configuration goal. However, the system administrator must coordinate the scripts manually. For example, the system administrator may have to execute Script A 402, capture the output of Script A 402, provide the output to the input of Script B 404, and then execute Script B 404. In some cases, a system administrator will capture the output of the Script A 402 by writing the output by hand, and then manually entering the output as input into Script B 404. Similarly, Script C 406 will require manual coordination with Script A 402 and Script B 404. This process is also tedious.

FIG. 5 is a flowchart illustrating a prior art method of executing a job on a single data processing system. The method shown in FIG. 5 is an illustrative example described in the preceding paragraph. The method shown in FIG. 5 may be implemented on any one of data processing systems 302, 304, or 306 in FIG. 3. The job may be job 400 shown in FIG. 4.

The process begins as the system administrator causes the data processing system to execute Script A on the data processing system (step 500). The system administrator then manually captures the output of Script A, such as by manually writing down the output or manually creating a file containing the output (step 502). For example, Script A may be a set of commands which lists all devices connected to the data processing system and the configurations for those devices.

Thereafter, the system administrator enters the output of Script A as input into Script B (step 504). For example, the system administrator may manually enter the names of all devices discovered with Script A into the input of Script B. The system administrator then causes the data processing system to execute Script B (step 506). In this example, Script C cannot be executed until Script B has been executed. Once Script B has been executed, the system administrator causes Script C to be executed (step 508). The process terminates thereafter.

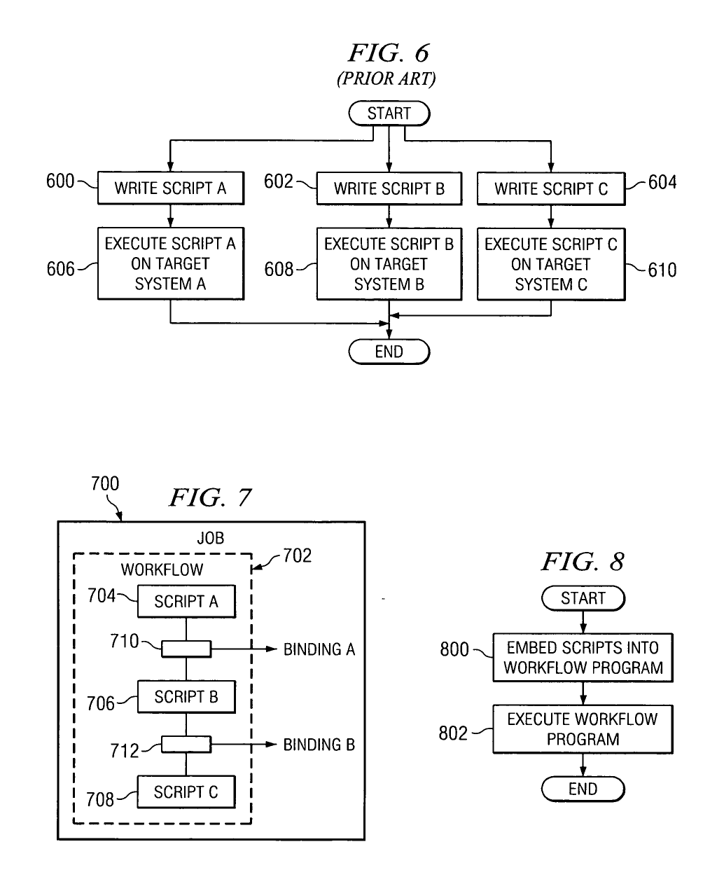

FIG. 6 is a flowchart illustrating another prior art method of accomplishing data processing job 400 shown in FIG. 4. The method shown in FIG. 6 is an illustrative example of the method described above with regard to multiple data processing systems on a network. The method shown in FIG. 6 may be implemented on data processing systems 302, 304, and 306 within data center 300 in FIG. 3. The job may be job 400 shown in FIG. 4. Thus, in the illustrative example shown in FIG. 6, Script A 402, Script B 404, and Script C 406 are written in different programming languages, though each accomplishes the same configuration goal on their respective data processing systems.

The process begins as the system administrator writes Script A (step 600), Script B (step 602), and Script C (step 604). Each script is written individually. Each script is then executed on the appropriate respective target data processing systems, System A, System B, and System C (steps 606, 608, and 610, respectively). The process terminates thereafter.

In the example shown in FIG. 6, if the output of one script is needed as input for another script, then the output often must be recorded manually and then manually provided to the other script. This process can be complicated and error prone as a system manager manually attempts to manage the outputs and inputs of the various scripts on the various different data processing systems. As the number of data processing systems increase the problem can exponentially increase.

FIG. 7 is a block diagram of a data processing job 700, in accordance with an embodiment of the present invention. As with one of the examples illustrated with respect to job 400 shown in FIG. 4, job 700 requires that Script A 704, Script B 706, and Script C 708 each be executed on one data processing system. Each script is a program. Again, each script 704, 706, and 708 is written in a different programming language. Furthermore, the output of Script A 704 is used as input for Script B 706.

However, the mechanism of an embodiment of the present invention provides a means for embedding Script A 704, Script B 706, and Script C 708 into a single workflow program 702 that may be executed on the data processing system. By embedding the scripts into a single workflow program, each script may also be executed on the data processing system automatically, with parameters, outputs, and other factors coordinated among the various programs associated with the scripts.

The workflow program 702 includes binding parameters, embedding parameters, and optionally global parameters. An embedding parameter embeds a particular script or program into the workflow program. Thus, the embedding parameter allows a script to become a part of the workflow program.

A binding parameter, such as Binding A 710 and Binding B 712, is accomplished using language binding. Language binding is responsible for passing script parameters, such as input and output. Language binding is also responsible for integration of error handling between workflows and scripts. For example, a script can raise an exception that can be handled by the workflow code. In addition, language binding is also responsible for integration of logging between workflows and scripts. A specific language binding exists for each programming language that can be embedded in the workflow program. Language binding takes the script code embedded in the workflow program, adds code that allows parameter bindings, error handling, and error logging, and passes the resultant code to a specific runtime interpreter.

Thus, language bindings allow the workflow program to coordinate scripts embedded in the workflow program. For example, a first language binding associated with a first script can take the output of the first script and store the output as a variable of the workflow program. The workflow program then provides the variable to the input of a second script. A second language binding language binding associated with a second script is needed to receive the input contained in the variable. In another example, the first and second language bindings store error codes from the first and second programs, respectively, as variables. The workflow program can then coordinate the error codes.

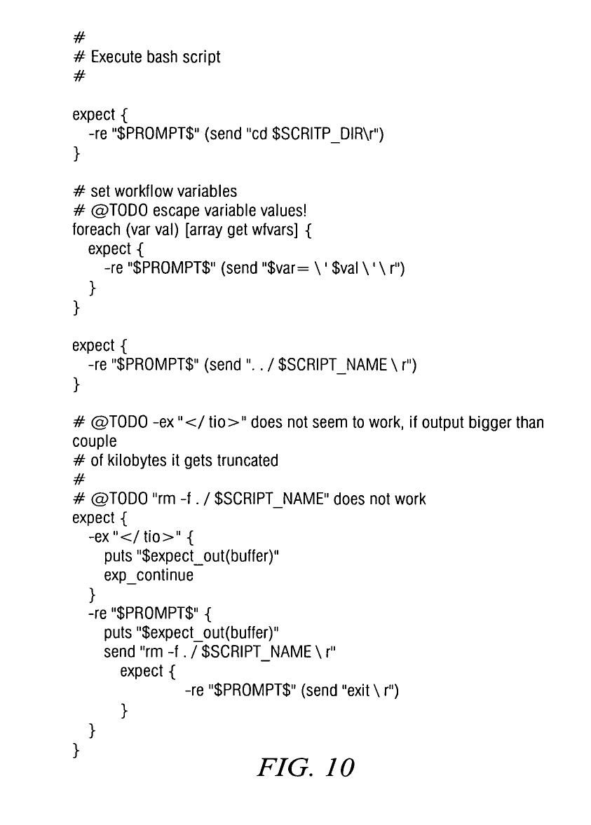

The language binding for BASH uses BASH environment variables to pass parameters to a script and a standard output stream is used to handle output. Language bindings can be provided for different programming languages, including but not limited to BASH, PERL, VBSCRIPT, PYTHON, and EXPECT. An example of a language binding is shown in FIG. 10.

Thus, workflow language acts as a glue for handling multiple scripts written in multiple programming languages, even when each script is designed to work with a different type of program or each script is written in a different programming language. The workflow program allows for integrated error handling, output passing, parameter passing, event logging, and in other ways coordination of the different scripts embedded in the workflow program. In addition, the workflow language allows multiple scripts in different languages to be joined into a single workflow program. In this case, when the workflow program is executed on a management device, the workflow program will cause each embedded script to be executed on a data processing system that supports the script program language.

In an example of the first function of the workflow program, a first program is configured using BASH scripts and a second program is configured using PERL scripts. (An example of a workflow program is shown in FIG. 12.) The output of the BASH script will be used in the PERL script. To coordinate the two scripts, both the BASH script and the PERL script are embedded into a workflow program and appropriate language bindings are included in the workflow program. When the workflow program is executed on the-data processing system, the embedded BASH script is executed and the resultant output is captured by the workflow program. The output, which is a parameter of the BASH script, may be stored as a variable of the workflow program. The workflow program then, if necessary, converts the output to a form usable by the embedded PERL script. In any case, the workflow program provides the output to the embedded PERL script as input. The workflow program causes the embedded PERL script to be executed. Any final results are captured or logged by the workflow program, if necessary, with the process terminating thereafter. The workflow program handles and/or coordinates any error codes generated by the PERL script, the BASH script, or both scripts. Thus, the workflow program handles variables commonly shared by different scripts.

In the case where different scripts are to be executed on different data processing systems connected via a network, the workflow program can coordinate execution of the different scripts. For example, a first script only works on a first data processing system and a second script only works on a second data processing system. Both scripts are embedded into a workflow program. The workflow program is executed on a management data processing system, which is also connected to the network. When appropriate, the workflow program causes the first script to be executed on the first data processing system. When appropriate, the workflow program causes the second script to be executed on the second data processing system.

The workflow program can combine both of the above functions. Continuing the example from the previous paragraph, the workflow program can capture the output of the first script, store the output as a variable, and use the variable as input into the second script. Thus, the workflow program can coordinate multiple scripts that use different programming languages and that are executed on different data processing systems.

Optionally, a global parameter handles matters global to the overall workflow program 702, such as the overall input or output of the workflow program and the overall integrity of the integrated workflow program. Global parameters may also add to the workflow program such that the workflow program accomplishes tasks other than the sum of the scripts embedded in the workflow program. Thus, the function of the workflow program may be greater than the sum of the functions of the scripts embedded in the workflow program.

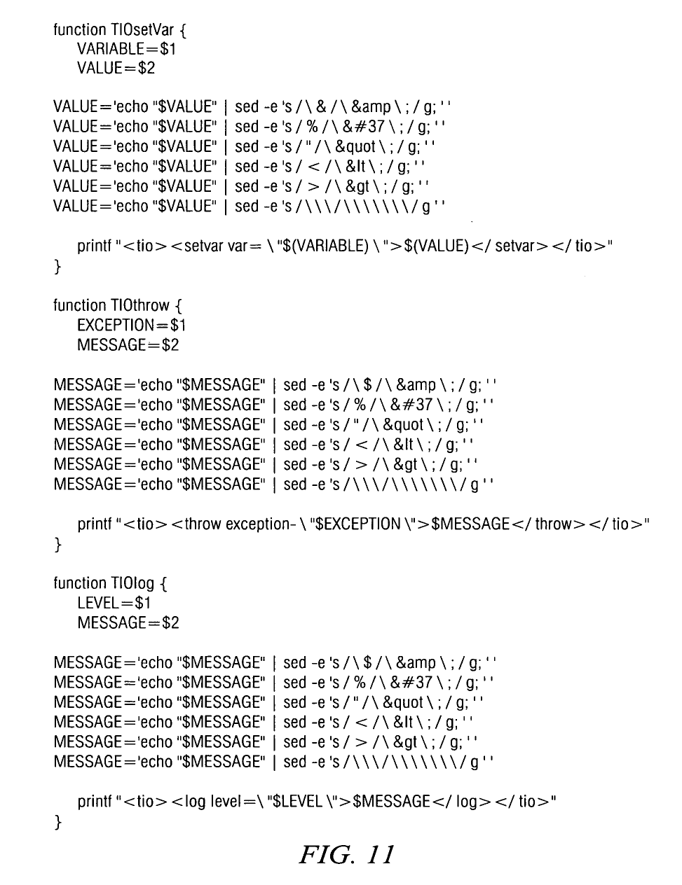

The workflow language itself may provide instructions for variable declarations, variable assignments, conditional execution, looping, error handling, workflow invocation, overall output or input of the workflow program, and other parameters that affect the various aspects of the workflow program. FIG. 10 and FIG. 11 show examples of language bindings. FIG. 12 shows an example of a workflow program.

FIG. 8 is a flowchart illustrating a method of accomplishing the data processing job 700 shown in FIG. 7, in accordance with an embodiment of the present invention. First, a programmer embeds the target scripts into a workflow program (step 800). In an illustrative embodiment, any language bindings are included automatically. Preferably, the manufacturer of the workflow programming language creates the language bindings so that that a system administrator need not provide support for specific script languages. Thus, the step of providing language bindings is performed automatically as each script is embedded or, optionally, after all or some of the scripts have been embedded.

However, in other embodiments, the step of embedding the target scripts into the workflow program also includes creating and adding any necessary language bindings for each language used in the workflow program. In addition, the step of embedding the scripts also includes adding any global parameters to the workflow program that may be desired.

In an embodiment, the workflow program is executed on only one data processing system (step 802). The workflow program coordinates execution of multiple scripts wherein one or more of the scripts are used to configure different programs on the data processing system. The workflow program may be executed on the target data processing system. The workflow program may also be executed on a remote management data processing system, with management actions taken on a target data processing system.

In another illustrative embodiment, each script within the workflow must be executed on separate data processing systems in a data center. In this case, the workflow program is executed on one target data processing system, though the workflow program coordinates execution of all scripts on all data processing systems. Thus, a workflow program may contain Script A and Script B, which must run on two different data processing systems. The overall results of Script A and Script B are used in Script C, which is to be executed a third data processing system. The workflow program causes Script A to be executed on the first data processing system and Script B to be executed on the second data processing system. The workflow program then takes the outputs from Script A and Script B, uses the outputs as input in Script C, and then executes Script C on the third data processing system.

Thus, in order to perform a job on a plurality of different data processing systems in a data center, only one workflow program need be created. Comparing the methods described in relation to FIG. 7 and FIG. 8 to the methods described in relation to FIG. 3 through FIG. 6, it is apparent that the mechanism of an embodiment of the present invention may greatly reduce the complexity of performing jobs in a data processing center or data processing environment. Another advantage of the workflow language described herein is that the single workflow program may be easily understood, maintained, and debugged. Furthermore, the workflow language may be used to fully integrate the desired scripts or programs into a single program that handles any interrelated functions of the various individual scripts or programs.

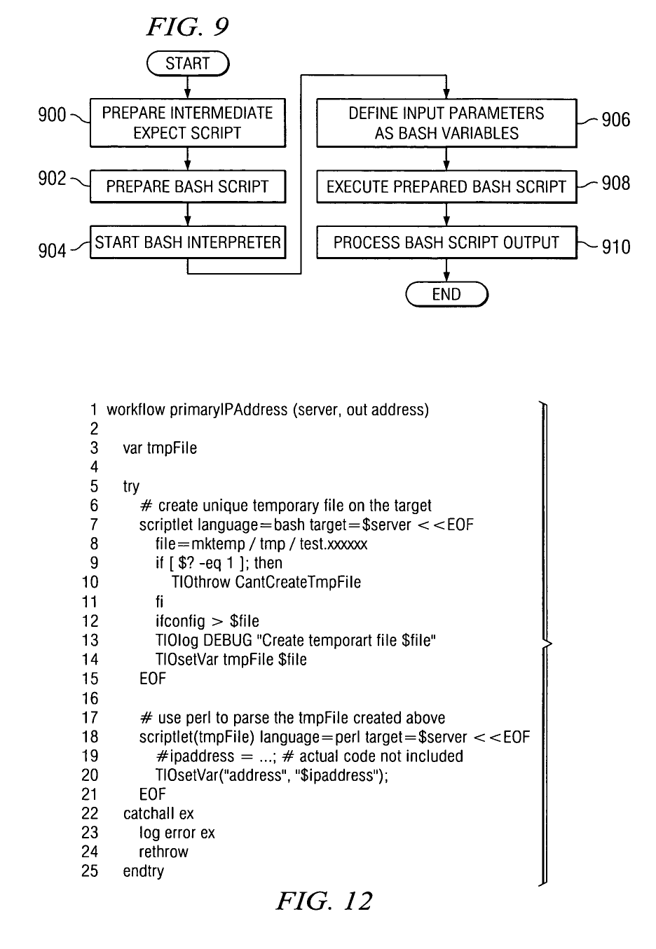

FIG. 9 is a flowchart illustrating an example of an operation of a workflow execution engine, in accordance with an embodiment of the present invention. The method shown in FIG. 9 illustrates communication between a workflow execution engine, an intermediate EXPECT script, and a BASH script within a workflow program and may be implemented in data processing systems and data centers, such as those shown in FIG. 1, FIG. 2, and FIG. 3.

First, a workflow execution engine prepares an intermediate EXPECT script by merging BASH input bindings with script input parameters (step 900). An example of BASH input bindings, which is also an example of language binding, is shown in FIG. 10. Script input parameter values come from a workflow execution state maintained by the workflow execution engine.

Next, the workflow execution engine prepares an executable BASH script by merging BASH output bindings with a BASH script embedded into a workflow program (step 902). An example of BASH output bindings, which is also an example of language binding, is shown in FIG. 11. The BASH output bindings define BASH functions which embedded BASH scripts can use to send information back to the workflow execution engine.

Thereafter, the workflow execution engine starts a BASH interpreter (step 904). An intermediate EXPECT script sends commands to the BASH interpreter and defines script input parameters as BASH environment variables (step 906). The workflow execution engine then instructs the BASH interpreter to execute the prepared BASH script (step 908). The workflow execution engine then processes the BASH script output (step 910). Processing output can include updating workflow execution variable values, adding new records to a workflow execution log, handling script execution errors, or handling any other outputs.

FIG. 10 is an example of BASH input bindings, in accordance with an embodiment of the present invention. The BASH input bindings shown in FIG. 10 may be used in the process shown in FIG. 9. The BASH input bindings are also examples of language binding described elsewhere in the specification.

FIG. 11 is an example of BASH output bindings, in accordance with an embodiment of the present invention. The BASH output bindings shown in FIG. 11 may be used in the process shown in FIG. 9. The BASH output binding shown define three BASH functions, TIOsetVar, TIOthrow, and TIOlog. Embedded BASH scripts can use each of these functions to send information back to the workflow execution engine. The BASH output bindings shown are also examples of language binding described elsewhere in the specification.

FIG. 12 shows an example of a workflow program, in accordance with an embodiment of the present invention. The workflow program shown in FIG. 12, entitled “primaryIPAddress,” shows how to use embedded scripts to determine the primary management IP address of a remote system. Line 1 illustrates declaring a workflow name; one workflow input parameter, “server,” which defines a target data processing system; and one workflow output parameter, “address.” Line 3 illustrates declaring a workflow local variable that will be used to pass information from a first scriptlet to a second scriptlet.

Line 7 through line 15 illustrates an embedded BASH script that creates a temporary file and populates it with information about the IP system's addresses. The scriptlet is written on BASH and will be executed on a remote data processing system defined by the “server” workflow input parameter. Line 10 illustrates how the BASH scriptlet can raise an exception. This exception will be handled by a workflow “catchall” statement illustrated on line 22. Line 13 shows how the BASH scriptlet can cause a debug message to be written to an execution log. Line 14 shows how the BASH scriptlet can set a value of a workflow local variable.

Line 18 through line 21 illustrate an embedded PERL scriptlet. The actual logic of the PERL script is not shown in FIG. 12. Line 21 illustrates how the PERL scriptlet can set a value of a workflow output parameter.

Line 22 through line 24 illustrates how the workflow program can handle exceptions raised from within the two embedded scriptlets, completing the exemplary workflow program. Although the workflow program shown in FIG. 12 shows an example of a workflow program, many different workflow programs may be written using a variety of scripts and using a variety of different parameters. Thus, the workflow program shown in FIG. 12 does not necessarily limit the present invention.

It is important to note that while embodiments of the present invention have been described in the context of a fully functioning data processing system, those of ordinary skill in the art will appreciate that the processes of embodiments of the present invention are capable of being distributed in the form of a computer usable medium of instructions and a variety of forms and that embodiments of the present invention apply equally regardless of the particular type of signal bearing media actually used to carry out the distribution. Examples of computer usable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer usable media may take the form of coded formats that are decoded for actual use in a particular data processing system.

The description of embodiments of the present invention have been presented for purposes of illustration and description, and are not intended to be exhaustive or limited to the invention in the form disclosed. Many modifications and variations will be apparent to those of ordinary skill in the art. The embodiments were chosen and described in order to best explain the principles of the invention, the practical application, and to enable others of ordinary skill in the art to understand the invention for various embodiments with various modifications as are suited to the particular use contemplated.

What is claimed is:

1. A method of coordinating programs in a data processing system, said method comprising:
embedding a first program into a workflow program, said first program written in a first programming language;
embedding a second program into the workflow program, said second program written in a second programming language;
including a first language binding in the workflow program, said first language binding adapted to coordinate the first program with the workflow program; and
including a second language binding in the workflow program, said second language binding adapted to coordinate the second program with the workflow program;
wherein the first programming language is different than the second programming language.

2. The method of claim 1 wherein:
the first language binding coordinates the first program with the workflow program by passing one of an output, an error code, and a log as a variable to the workflow program; and
the second language binding coordinates the second program with the workflow program by causing the variable to be used as input into the second program.

3. The method of claim 1 wherein the one of the first language binding and the second language binding is adapted to coordinate programs written in a language selected from the group consisting of BASH, EXPECT, PERL, PYTHON, and VBSCRIPT.

4. The method of claim 1 wherein the first programming language is incompatible with the second programming language.

5. The method of claim 1 wherein the first program is executed in the data processing system, the second program is executed in a second data processing system, and the workflow program is executed in a third data processing system.

6. The method of claim 1 wherein both the first program and the second program are executed on the data processing system.

7. The method of claim 6 wherein the workflow program is executed on the data processing system.

8. A computer program product, comprising computer executable instructions embodied in a computer usable medium, for coordinating programs in a data processing system, said computer program product comprising:
first instructions for embedding a first program into a workflow program, said first program written in a first programming language;
second instructions for embedding a second program into the workflow program, said second program written in a second programming language;
third instructions for including a first language binding in the workflow program, said first language binding adapted to coordinate the first program with the workflow program; and
fourth instructions for including a second language binding in the workflow program, said second language binding adapted to coordinate the second program with the workflow program;
wherein the first programming language is different than the second programming language.

9. The computer program product of claim 8 wherein:
the third instructions includes sub-instructions for passing one of an output, an error code, and a log as a variable to the workflow program; and
the fourth instructions includes sub-instructions for causing the variable to be used as input into the second program.

10. The computer program product of claim 8 wherein the third instructions and the fourth instructions include sub-instructions for coordinating programs written in a language selected from the group consisting of BASH, EXPECT, PERL, PYTHON, and VBSCRIPT.

11. The computer program product of claim 8 wherein the first programming language is incompatible with the second programming language.

12. The computer program product of claim 8 further comprising:
fifth instructions for executing the first program in the data processing system;
sixth instructions for executing the second program in a second data processing system; and
seventh instructions for executing the workflow program in a third data processing system.

13. The computer program product of claim 8 further comprising:
fifth instructions for executing both the first program and the second program on the data processing system.

14. The computer program product of claim 13 further comprising:
sixth instructions for executing the workflow program on the data processing system.

15. A data processing system comprising:
a bus;
a memory, wherein a set of instructions is located in the memory;
a processor operably connected to the bus, said processor executing the set of instructions to:
embed a first program into a workflow program, said first program written in a first programming language;
embed a second program into the workflow program, said second program written in a second programming language;
include a first language binding in the workflow program, said first language binding adapted to coordinate the first program with the workflow program; and
include a second language binding in the workflow program, said second language binding adapted to coordinate the second program with the workflow program;
wherein the first programming language is different than the second programming language.

16. The data processing system of claim 15 wherein the processor is further adapted to execute the instructions to:
coordinate the first program with the workflow program using the first language binding by passing one of an output, an error code, and a log as a variable to the workflow program; and
coordinate the second program with the workflow program using the second language binding by causing the variable to be used as input into the second program.

17. The data processing system of claim 15 wherein the one of the first language binding and the second language binding is adapted to coordinate programs written in a language selected from the group consisting of BASH, EXPECT, PERL, PYTHON, and VBSCRIPT.

18. The data processing system of claim 15 wherein the first programming language is incompatible with the second programming language.

19. The data processing system of claim 18 wherein the processor is further adapted to execute the set of instruction to:
execute the first program on a second data processing system; and
execute the second program on a third data processing system.

20. The data processing system of claim 19 wherein the processor is further adapted to execute the instructions to:
coordinate the first program with the workflow program using the first language binding by passing one of an output, an error code, and a log as a variable to the workflow program; and
coordinate the second program with the workflow program using the second language binding by causing the variable to be used as input into the second program.
